(19) United States
(12) Patent Application Publication
(10) Pub. No.: US 2009/0325086 A1
(43) Pub. Date: Dec. 31, 2009

(54) COLOR FILTER AND METHOD OF FABRICATING THE SAME

(75) Inventor: Yan-Hsiu Liu, Tainan City (TW)

Correspondence Address: J C PATENTS, 4 VENTURE, SUITE 250, IRVINE, CA, 92618, US

(73) Assignee: UNITED MICROELECTRONICS CORP., Hsinchu (TW)

(21) Appl. No.: 12/163,291

(22) Filed: Jun. 27, 2008

(51) Int. Cl. G11B 7/16

(52) U.S. Cl. 430/7

(57) ABSTRACT

A method of fabricating a color filter having a target transmittance distribution is provided. First, a substrate having a first photodetector thereon is provided. Thereafter, a first pixel having a first transmittance distribution is formed on the substrate. The method of forming the first pixel includes forming a first organic color photoresist layer on the first photodetector, and then forming a second organic color photoresist layer on the first organic color photoresist layer, wherein the first and second organic color photoresist layers have different transmittance distributions.

### BACKGROUND OF THE INVENTION

1. Field of Invention

The present invention relates to a semiconductor device and a method of fabricating the same, and more particularly to a color filter and a method of fabricating the same.

2. Description of Related Art

Generally, in a process for fabricating a color filter, commercially available color photoresist materials with three primary colors, such as red, green and blue color photoresist materials, are processed three times in a photolithography module, so that three color photoresist layers are respectively formed on different pixels of the substrate to form a color filter.

As various color filters are developed for different applications, customers often demand for a product appeared with a customized color. However, fabricating such a customized color photoresist material is not economical; thus, the request of customers is hardly met.

Further, difficulties occur in the applications of commercially available color photoresist materials. For example, commercially available color photoresist materials have a wider transmittance distribution, so that filtering off the certain wavelength is hardly achieved. In addition, the commercially available black color photoresist material is not completely light-shielding and still has about 10% to 30% transmittance in certain wavelength range, resulting in detection errors of a photodetector. Therefore, to fabricate a color filter having a certain transmittance distribution without increasing the cost has been actively pursued in the industry.

### SUMMARY OF THE INVENTION

The present invention provides a method of fabricating a color filter, in which a customized color can be fabricated with commercially available color photoresist materials, so that the cost is greatly reduced and the competitiveness is significantly improved.

The present invention also provides a color filter to meet the customer request for filtering off the certain wavelength range by stacking multiple color photoresist layers.

The present invention provides a method of fabricating a color filter having a target transmittance distribution. First, a substrate is provided and the substrate has a first photodetector formed thereon. Thereafter, a first pixel having a first transmittance distribution is formed on the first photodetector. The method of forming the first pixel includes forming a first organic color photoresist layer on the first photodetector, and then forming a second organic color photoresist layer on the first organic color photoresist layer. The first and second organic color photoresist layers have different transmittance distributions.

According to an embodiment, colors of the first and second organic color photoresist layers include red, green, blue, cyan, magenta, yellow and black.

According to an embodiment, the step of forming the first pixel further includes forming at least one organic color photoresist layer on the second organic color photoresist layer. A color of the at least one organic color photoresist layer includes red, green, blue, cyan, magenta, yellow and black.

According to an embodiment, the first transmittance distribution and the target transmittance distribution are substantially the same.

According to an embodiment, the method of fabricating a color filter further includes forming at least one second pixel on the substrate, wherein the second pixel has a second transmittance distribution, the substrate further includes at least one second photodetector, and the second pixel is on the second photodetector.

According to an embodiment, the first transmittance distribution and the second transmittance distribution form the target transmittance distribution.

According to an embodiment, the step of forming the second pixel includes forming at least one organic color photoresist layer on the second photodetector. A color of the at least one organic color photoresist layer includes red, green, blue, cyan, magenta, yellow and black.

The present invention also provides a color filter having a target transmittance distribution. The color filter is fabricated by the above-mentioned method.

According to the color filter and the fabrication method thereof, all processes which require a special function or a customized color can be fabricated by stacking multiple organic color photoresist layers on a single pixel; thus, the cost is greatly saved and the competitiveness is significantly improved.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a diagram of transmittance as a function of wavelength of a color filter according to a first embodiment of the present invention.

FIGS. 1A to 1B schematically illustrate, in a cross-section view, a method of fabricating a color filter according to a first embodiment of the present invention.

FIG. 2 schematically illustrates a diagram of transmittance as a function of wavelength of a color filter according to a second embodiment of the present invention.

FIGS. 2A to 2B schematically illustrate, in a cross-section view, a method of fabricating a color filter according to a first embodiment of the present invention.

### DESCRIPTION OF EMBODIMENTS

### First Embodiment

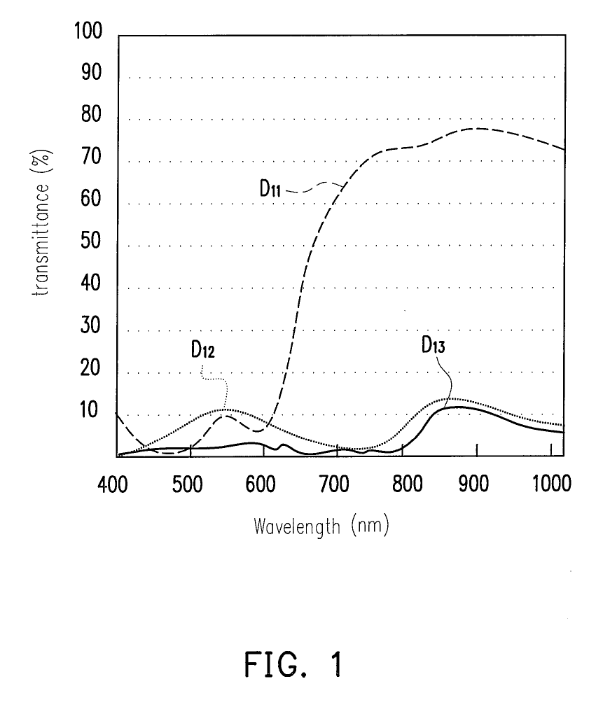

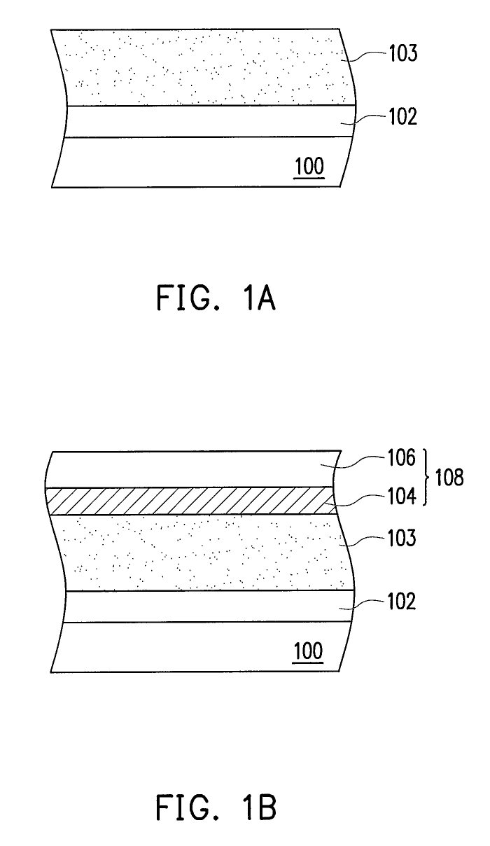

FIG. 1 schematically illustrates a diagram of transmittance as a function of wavelength of a color filter according to a first embodiment of the present invention. FIGS. 1A to 1B schematically illustrate, in a cross-section view, a method of fabricating a color filter according to a first embodiment of the present invention.

In the first embodiment, a color filter for detecting the infrared light and sensing a heat source is fabricated, for example. This color filter has a target transmittance distribution D₁₄, substantially blocking most of the visible light and allowing the infrared light of 700 to 1000 nm to pass through.

Referring to FIG. 1A, a substrate 100 is provided. The substrate 100 has a photodetector 102 formed thereon. The substrate 100 may be a silicon substrate. The photodetector 102 may be a photodiode. In this embodiment, a dielectric layer 103 is formed on the photodetector 102. The material of the dielectric layer 103 includes silicon oxide, silicon nitride, silicon oxynitride or combinations thereof, for example. The dielectric layer 103 can also be a stacking structure including a bottom PE-TEOS layer and a top silicon oxynitride layer. The method of forming the dielectric layer 103 is a CVD process, for example.

Referring to FIGS. 1 and 1B, an organic color photoresist layer 104 is formed on the photodetector 102. The organic color photoresist layer 104 is a black color photoresist layer having a transmittance distribution D₁₁, for example. As shown in FIG. 1, the black color photoresist layer has two small peaks respectively at 400 to 700 nm (visible spectrum) and 700 to 1000 nm (infrared spectrum); that is, these two wavelength ranges of light can transmit through the black color photoresist layer and are detected by the photodetector 102 disposed thereunder.

Thereafter, an organic color photoresist layer 106 is formed on the organic color photoresist layer 104. The organic color photoresist layer 106 is a red color photoresist layer having a transmittance distribution D₁₂, for example. As shown in FIG. 1, the red color photoresist layer basically allows the light of more than 500 nm to pass through, but blocks the light of less than 500 nm.

In this embodiment, the first and second organic color photoresist layers 104 and 106 are stacked to form a pixel 108. The method of forming the color photoresist layers 104 and 106 is a spin-coating process, for example.

Referring to FIG. 1, the transmittance distribution D₁₁ multiplied by the transmittance distribution D₁₂ is the transmittance distribution D₁₃ of the pixel 108. The transmittance distribution D₁₃ has a low transmittance in the visible spectrum but maintains a certain transmittance in the infrared spectrum, so that the color filter including the pixel 108 is suitable for detecting the infrared light.

In details, the transmittance distribution D₁₃ has the certain transmittance in 700 to 1000 nm by applying the organic color photoresist layer 104. On the other side, the transmittance in 400 to 700 nm of the transmittance distribution D₁₃ can be reduced to very low by stacking the organic color photoresist layer 106 on the organic color photoresist layer 104.

The conventional method of blocking the visible light is by coating a black photoresist layer. However, the commercially available black color photoresist material still has 10% to 30% transmittance, so that detection errors are often observed. The pixel 108 of the present invention including the organic color photoresist layer 104 (such as a black color photoresist layer) and the organic color photoresist layer 106 (such as a red color photoresist layer) can successfully block most of the infrared light to solve the above-mentioned problem, so that the color filter including the pixel 108 is applicable for detecting the infrared light and sensing if a heat source is present.

The color filter of the first embodiment only includes the pixel 108; that is, the target transmittance distribution D₁₄ of the color filter and the transmittance distribution D₁₃ of the pixel 108 are substantially the same.

In the first embodiment, by the coating of two organic color photoresist layers and the multiplication effect on transmittance distributions of the same, the transmittance distribution in the non-target wavelength range is reduced as much as possible while the transmittance distribution in the target wavelength range remains. It is appreciated by persons skilled in the art that more than two organic color photoresist layers can be coated upon the process requirement.

The present invention can be applicable for fabricating a customized color. For example, multiple organic color photoresist layers are stacked on a single pixel, so that the target transmittance distribution of the customized color is obtained by adjusting the combinations of the thicknesses, forming sequences and compositions of these layers.

Further, the organic color photoresist layers according to the present invention may include commercially available photoresist materials, such as photoresist materials with three primary colors or black color. In details, the colors of the organic color photoresist layers include red, green, blue, cyan, magenta, yellow and black.

### Second Embodiment

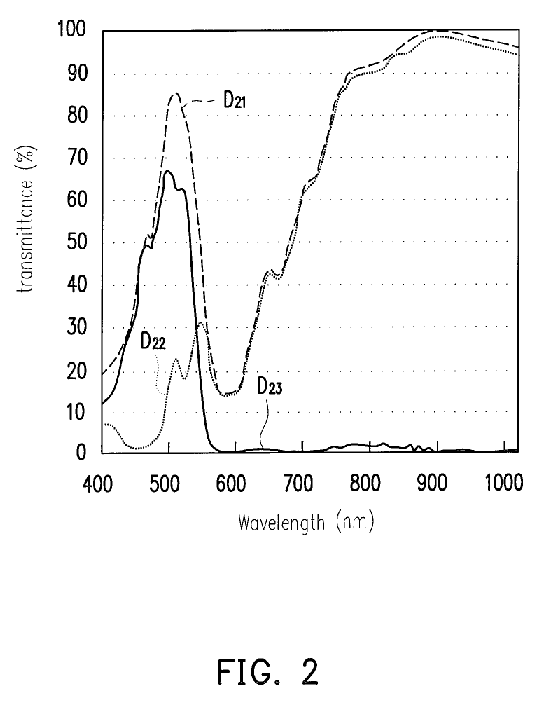

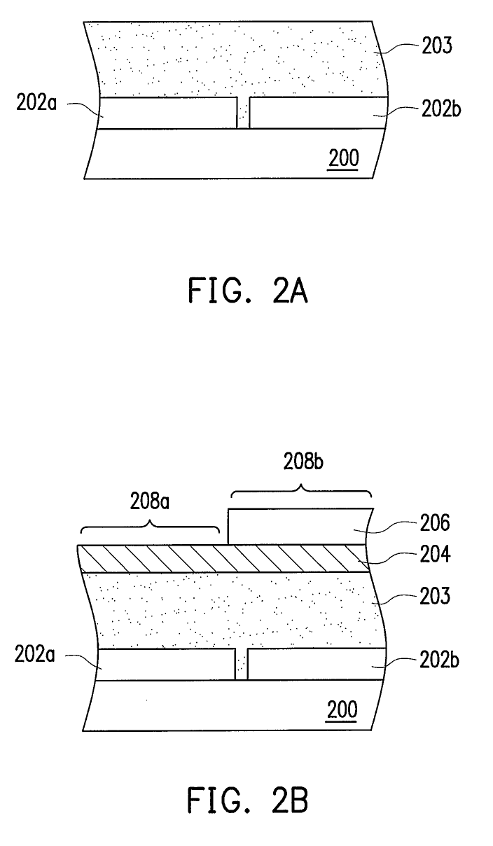

FIG. 2 schematically illustrates a diagram of transmittance as a function of wavelength of a color filter according to a second embodiment of the present invention. FIGS. 2A to 2B schematically illustrate, in a cross-section view, a method of fabricating a color filter according to a first embodiment of the present invention.

In the second embodiment, a color filter for simulating human eyes is fabricated, for example. This color filter has a target transmittance distribution D₂₄ with a high transmittance in the visible spectrum and a low transmittance in the infrared spectrum.

Referring to FIG. 2A, a substrate 200 is provided. The substrate 200 has photodetectors 202a and 202b formed thereon. The substrate 200 may be a silicon substrate. The photodetectors 202a and 202b may be photodiodes. In an embodiment, a dielectric layer 203 is formed on the photodetectors 202a and 202b.

Thereafter, an organic color photoresist layer 206 corresponding to the photodetectors 202b is formed on the organic color photoresist layer 204. The organic color photoresist layer 206 is a red color photoresist layer, for example. The method of forming the organic color photoresist layer 206 includes forming a red color photoresist material layer (not shown) on the organic color photoresist layer 204, and then performing an exposure-and-development process to remove a portion of the red color photoresist material layer corresponding to the photodetector 202a, so that the organic color photoresist layer 206 corresponding to the photodetectors 202b remains.

Referring to FIGS. 2 and 2B, the organic color photoresist layers 204 and 206 are divided into pixels 208a and 208b in terms of the positions of the photodectors 202a and 202b. The pixel 208a disposed on the photodector 202a is a single-layer structure including a portion of the organic color photoresist layer 204, and the pixel 208a has a transmittance distribution D₂₁. The pixel 208b disposed on the photodector 202b is a double-layer structure including a portion of the organic color photoresist layer 204 and a portion of the organic color photoresist layer 206, and the pixel 208b has a transmittance distribution D₂₂.

As shown in FIG. 2, the transmittance distribution D₂₁ of the pixel 208a has two peaks respectively at 400 to 600 nm and 600 to 1000 nm. The transmittance distribution D₂₂ of the pixel 208b also has two peaks respectively at 400 to 600 nm and 600 to 1000 nm; in details, the transmittance in 400 to 600 nm of the pixel 208b is lower than that of the pixel 208a, but the transmittance in 600 to 1000 nm of the pixel 208b is almost overlapped with that of the pixel 208a.

In this embodiment, the pixel 208a is regarded as an actual pixel, and the pixel 208b is regarded as a reference pixel. The transmittance distribution D₂₂ is subtracted from the transmittance distribution D₂₁ to take off the background infrared signal (i.e. the transmittance in 600 to 1000 nm), so that a transmittance distribution D₂₃ is obtained. The transmittance distribution D₂₃ has a high transmittance in 400 to 600 nm and a very low transmittance in 600 to 1000 nm, so that the ideal sensitivity of human eyes can be simulated.

The color filter of the second embodiment includes the pixels 108a and 108b; that is, the transmittance distribution D₂₁ and the transmittance distribution D₂₂ form the transmittance distribution D₂₃, which is substantially the same as the target transmittance distribution D₂₄ of the color filter.

The second embodiment in which the actual pixel is a single-layer structure and the reference pixel is a double-layer structure is provided for illustration purposes, and is not to be construed as limiting the present invention. It is appreciated by persons skilled in the art that both the actual pixel and the reference pixel can be multi-layer structures, as long as the purpose of the present invention is achieved; that is, the transmittance distribution in the non-target wavelength range is filtered off while the transmittance distribution in the target wavelength range remains. Further, the number of the reference pixel is not limited by the present invention; in other words, one or more reference pixels are allowable in the present invention.

In summary, by stacking multiple organic color photoresist layers on a single pixel, not only a customized color can be fabricated, but also the special customer request, such as fabricating a color filter for detecting the infrared light or simulating human eyes, can be met. Further, the method of fabricating the color filter according to the present invention is very simple without the requisite of purchasing a new photoresist material or adding a new process step; thus, the cost can be greatly saved and the competitiveness can be significantly improved.

This invention has been disclosed above in the preferred embodiments, but is not limited to those. It is known to persons skilled in the art that some modifications and innovations may be made without departing from the spirit and scope of this invention. Hence, the scope of this invention should be defined by the following claims.

What is claimed is:

1. A method of fabricating a color filter having a target transmittance distribution, comprising:
providing a substrate, the substrate having a first photodetector formed thereon; and
forming a first pixel having a first transmittance distribution on the first photodetector, comprising:
forming a first organic color photoresist layer on the first photodetector; and
forming a second organic color photoresist layer on the first organic color photoresist layer, wherein the first and second organic color photoresist layers have different colors.

2. The method of claim 1, wherein the colors of the first and second organic color photoresist layers comprise red, green, blue, cyan, magenta, yellow and black.

3. The method of claim 1, wherein the step of forming the first pixel further comprises forming at least one organic color photoresist layer on the second organic color photoresist layer.

4. The method of claim 3, wherein a color of the at least one organic color photoresist layers comprises red, green, blue, cyan, magenta, yellow and black.

5. The method of claim 1, wherein the first transmittance distribution and the target transmittance distribution are substantially the same.

6. The method of claim 1, further comprising forming at least one second pixel on the substrate, wherein the second pixel has a second transmittance distribution, the substrate further comprises at least one second photodetector, and the second pixel is on the second photodetector.

7. The method of claim 6, wherein the first transmittance distribution and the second transmittance distribution form the target transmittance distribution.

8. The method of claim 6, wherein the step of forming the second pixel comprises forming at least one organic color photoresist layer on the second photodetector.

9. The method of claim 8, wherein a color of the at least one organic color photoresist layer comprises red, green, blue, cyan, magenta, yellow and black.

10. A color filter, having a target transmittance distribution, disposed on a substrate having a first photodetector thereon, and comprising:
a first pixel, disposed on the first photodetector, having a first transmittance distribution, and comprising:
a first organic color photoresist layer, disposed on the first photodetector; and
a second organic color photoresist layer, disposed on the first organic color photoresist layer, wherein the first and second organic color photoresist layers have different colors.

11. The color filter of claim 10, wherein the colors of the first and second color photoresist layers comprise red, green, blue, cyan, magenta, yellow and black.

12. The color filter of claim 10, wherein the first pixel further comprises at least one organic color photoresist layer disposed on the second organic color photoresist layer.

13. The color filter of claim 12, wherein a color of the at least one color photoresist layers comprises red, green, blue, cyan, magenta, yellow and black.

14. The color filter of claim 10, wherein the first transmittance distribution and the target transmittance distribution are substantially the same.

15. The color filter of claim 10, further comprising at least one second pixel disposed on the substrate, wherein the second pixel has a second transmittance distribution, the substrate further comprises at least one second photodetector, and the second pixel is disposed on the second photodetector.

16. The color filter of claim 15, wherein the first transmittance distribution and the second transmittance distribution form the target transmittance distribution.

17. The color filter of claim 15, wherein the second pixel comprises at least one organic color photoresist layer on the second photodetector.

18. The color filter of claim 17, wherein a color of the at least one organic color photoresist layer comprises red, green, blue, cyan, magenta, yellow and black.
